(19) United States
(12) Patent Application Publication
(10) Pub. No.: US 2015/0030058 A9
(43) Pub. Date: Jan. 29, 2015

(54) CQI FEEDBACK FOR MIMO DEPLOYMENTS

(71) Applicants: Badri Varadarajan, Dallas, TX (US); Eko N. Onggosanusi, Allen, TX (US)

(72) Inventors: Badri Varadarajan, Dallas, TX (US); Eko N. Onggosanusi, Allen, TX (US)

(73) Assignee: Texas Instruments Inc., Dallas, TX (US)

(21) Appl. No.: 11/759,221

(22) Filed: Jun. 6, 2007

Related U.S. Application Data
(60) Provisional application No. 60/804,014, filed on Jun. 6, 2006.
(60) Provisional application No. 60/825,227, filed on Sep. 11, 2006.
(60) Provisional application No. 60/883,857, filed on Jan. 8, 2007.
(60) Provisional application No. 60/747,499, filed on May 17, 2006.

(51) Int. Cl. H04B 1/38; H04B 7/216

(52) U.S. Cl. 375/221; 370/342

(57) ABSTRACT

The present disclosure provides a receiver, a transmitter and methods of operating a receiver and a transmitter. In one embodiment, the receiver includes a receive portion employing transmission signals from a transmitter, having multiple transmit antennas, that is capable of transmitting at least one spatial codeword and adapting a transmission rank. The receiver also includes a feedback generator portion configured to provide a channel quality indicator that is feedback to the transmitter, wherein the channel quality indicator corresponds to at least one transmission rank.

### CROSS-REFERENCE TO PROVISIONAL APPLICATIONS

This application claims the benefit of U.S. Provisional Application No. 60/804014 entitled “CQI Feedback for Single Codeword Transmission in MIMO OFMA Systems” to Badri Varadarajan and Eko N. Onggosanusi, filed on Jun. 6, 2006, which is incorporated herein by reference in its entirety.

This application also claims the benefit of U.S. Provisional Application No. 60/825227 entitled “CQI Feedback Methods for MIMO Deployments of 3GPP LTE OFDMA” to Badri Varadarajan and Eko N. Onggosanusi, filed on Sep. 11, 2006, which is incorporated herein by reference in its entirety.

This application further claims the benefit of U.S. Provisional Application No. 60/883857 entitled “CQI Feedback for Per-Group Rate Control” to Eko N. Onggosanusi and Badri Varadarajan, filed on Jan. 8, 2007, which is incorporated herein by reference in its entirety.

### TECHNICAL FIELD

The present disclosure is directed, in general, to wireless communications and, more specifically, to a MIMO receiver and transmitter and methods of operating a MIMO receiver and transmitter.

### BACKGROUND

In a cellular network, such as one employing orthogonal frequency division multiplexing (OFDM) or orthogonal frequency division multiple access (OFDMA), each cell employs a base station that communicates with user equipment, such as a cell phone, a laptop, or a PDA, which is actively located within its cell.

Initially, the base station transmits reference signals (such as pilot signals) to the user equipment wherein the reference signals are basically an agreement between the base station and the user equipment that at a certain frequency and time, they are going to receive a known signal. Since the user equipment knows the signal and its timing, it can generate a channel estimate based on the reference signal. Of course, there are unknown distortions such as interference and noise, which impact the quality of the channel estimate.

Typically user equipments are at different locations within a cell with correspondingly different received signal strength and interference levels. Consequently, some user equipments (typically in the cell interior) can receive data at much higher data rates than other cell-edge user equipment. In order to optimally utilize the transmission time, it is desirable to ensure that the base station transmits to each user equipment in a manner tailored to the channel conditions experienced by the user equipment. Tailoring such a transmission is called link adaptation.

In an OFDM or OFDMA system, for example, different user equipment is scheduled for transmission on different portions of the system bandwidth. The system bandwidth may be divided into frequency-domain resource blocks of a certain size (sometime referred to as a sub-band) wherein a resource block is the smallest allocation unit available in terms of frequency granularity that can be allocated to the user equipment. While the size of different resource blocks can in general vary, it is often preferred to impose the same size across resource blocks. A different user equipment could potentially be assigned to each of these resource blocks. In addition, a user can be scheduled on a portion of the system bandwidth having adjacent resource blocks. Non-adjacent resource block allocation for each user equipment is also possible.

To enable the base station to perform link adaptation and user equipment scheduling, the user equipment has to feedback a channel quality indicator (CQI) based on its estimated channel condition. If the base station has a single transmit antenna, the use of channel quality indication for link adaptation and user equipment scheduling is well understood. However, since systems with multiple transmit and multiple receive antennas (i.e., multiple-input multiple output (MIMO) systems) offer greater flexibility in link adaptation and user equipment scheduling, improvements would prove beneficial in the art.

### SUMMARY

The present disclosure provides a receiver, a transmitter and methods of operating a receiver and a transmitter. In one embodiment, the receiver includes a receive portion employing transmission signals from a transmitter, having multiple transmit antennas, that is capable of transmitting at least one spatial codeword and adapting a transmission rank. The receiver also includes a feedback generator portion configured to provide a channel quality indicator that is feedback to the transmitter, wherein the channel quality indicator corresponds to at least one transmission rank.

In one embodiment, the method of operating a receiver includes receiving transmission signals from a transmitter having multiple transmit antennas that is capable of transmitting at least one spatial codeword and adapting a transmission rank. The method also includes feeding back a channel quality indicator to the transmitter, wherein the channel quality indicator corresponds to at least one transmission rank.

In one embodiment, the transmitter has multiple transmit antennas and is capable of transmitting at least one spatial codeword as well as adapting a transmission rank. The transmitter includes a feedback decoding portion configured to extract a channel quality indicator provided by a feedback signal from a receiver; wherein the channel quality indicator corresponds to at least one transmission rank. The transmitter also includes a transmit portion coupled to the multiple transmit antennas that provides a subsequent transmission based on the channel quality indicator.

In one embodiment, the method of operating a transmitter employs a transmitter having multiple transmit antennas that is capable of transmitting at least one spatial codeword and adapting a transmission rank. The method includes extracting a channel quality indicator provided by a feedback signal from a receiver and selecting a transmission rank and a modulation-coding scheme for the subsequent transmission in response to the decoded channel quality indicator feedback. The method also includes selecting a user in response to the decoded channel quality indicator feedback and generating a subsequent transmission with the multiple transmit antennas.

### BRIEF DESCRIPTION OF THE DRAWINGS

For a more complete understanding of the present disclosure, reference is now made to the following descriptions taken in conjunction with the accompanying drawings, in which:

FIG. 1A illustrates a system diagram of a receiver as provided by one embodiment of the present disclosure;

FIG. 1B illustrates a system diagram of a transmitter as provided by one embodiment of the present disclosure;

FIGS. 2A-2E illustrate diagrams of various transmitter configurations as provided by various embodiments of the disclosure;

FIG. 3A illustrates a flow diagram of an embodiment of a method of operating a receiver; and

FIG. 3B illustrates a flow diagram of an embodiment of a method of operating a transmitter.

### DETAILED DESCRIPTION

Embodiments of the present disclosure presented below are focused on feeding back channel quality indicators (CQIs) from a user equipment (UE) that employs a receiver to a base station (node B) that employs a transmitter having multiple transmit antennas. The CQI may be one of or a combination of various feedback quantities such as (but not limited to) the signal-to-interference plus noise ratio (SINR), preferred data rate or modulation-coding scheme, capacity-based or mutual information, and/or received signal power. The node B may use the CQI reported by the UEs to perform user selection, i.e., which UE to schedule on a given transmission bandwidth at a given time. Further, for the selected UE, the node B may determine a transmission rank, a coding scheme for different layers and a modulation scheme for each layer.

The transmission rank is the number of parallel, spatial layers to be transmitted to the UE. The transmission rank may be as high as the number of transmit antennas employed at the node B. Typically, UEs close to the node B are able to support higher transmission ranks than UEs further from the node B.

The signals on transmission layers are sometimes coded jointly, depending on the communication standard. In WiMax, for example, all transmission layers are always coded jointly. In the prior art, there is a pre-determined mapping between codewords and spatial layers, for each transmission rank. The present disclosure proposes to optionally determine the codeword-to-layer mapping adaptively depending on the CQI feedback from the UE.

Once the codeword-to-layer mapping is fixed, the node B determines the code rate to be used for each independent codeword. It also determines the modulation scheme on each transmission layer. In other standards, the modulation scheme is always the same for all layers which are coded jointly. In this case, the number of modulation schemes to be chosen equals the number of codewords.

The CQI feedback from the UE enables the node B to compute the entities discussed above for a given UE. The feedback structure from the UE has a two-layer format: the UE first chooses a set of preferred transmission ranks; then for each chosen rank, the UE feeds back channel quality indicators (CQIs). The present disclosure provides for various mechanisms to feed back the channel quality indicator.

One embodiment provides a mechanism to feedback the CQI in the form of signal-to-noise per codeword, assuming a fixed codeword-to-layer mapping for that rank That is, one codeword is assigned one CQI. This approach allows the node B to choose modulation and coding schemes per codeword. Since one codeword may contain more than one spatial layers, the modulation and coding scheme (rate) is the same for all the spatial layers corresponding to one codeword.

Another embodiment provides CQI in the form per-layer SINR feedback. Here, the UE feeds back the SINRs per layer without combining the SINRs according to codewords. Correspondingly, in one embodiment, the node-B may use the feedback SINRs to determine the codeword-to-layer mapping. Thus, the base station tries different codeword-to-layer mappings and picks the one with the maximum throughput. Note that the choice might be based on a joint choice across multiple time-frequency resource blocks, although each specific CQI reported is only for one resource block.

In another embodiment, the node B uses the feedback layer SINRs to select possibly different modulation schemes for different layers, even if they are jointly coded. For example, in a single-codeword transmission, only one codeword is used, irrespective of the number of layers. In this case, the embodiment allows the node B to choose different modulation schemes for different layers based on the per-layer SINR feedback.

In another embodiment, the UE feeds back CQI in the form of individual modulation schemes and one coding scheme for each set of jointly coded spatial layers. Here again, a fixed codeword-to-layer mapping is assumed for each transmission rank. It may also provide additional information about the expected error rate of such a scheduling mechanism. The node B in this case uses the recommended modulation and coding schemes in the subsequent transmission to the UE.

The above descriptions deal with the form of channel quality indicator for a given rank. To provide flexibility for scheduling across multiple resources, this disclosure also proposes CQI feedback for multiple transmission ranks rather than just one preferred rank. For each reported transmission rank, the UE feeds back either the per-layer SINR or the per-codeword effective SNR.

In one embodiment, the UE feeds back CQI for the preferred transmission rank and one higher rank (if any). In another embodiment, the user element feeds back CQI for the preferred transmission rank and one lower rank (if any) In yet another embodiment, the user element provides the list of transmission ranks for which CQI is fed back, along with the corresponding CQI. Using the above multiple-rank feedback, the base station may override the feedback rank on some resource blocks (e.g., where they are combined with other resource blocks).

Correspondingly, in one embodiment, the node B uses the multiple rank reports to pick a rank that is well-suited to existing traffic conditions and previously queued processes stored for retransmission.

In another embodiment, the node B uses the multiple rank reports from different UEs to enable multi-user scheduling. For example, if two UEs feed back CQIs having a preferred rank of one, but also feed back CQI for rank two, the node B may transmit simultaneously with a total rank of two, but with only one transmission stream to each UE.

Embodiments of the present disclosure also provide for dealing with specific receiver implementations like successive interference cancellation (SIC) decoders. In such receivers, the UE completely decodes one coded stream first, and then reconstructs the data transmitted in that stream to cancel out the interference to the other streams, which are subsequently decoded. While such receivers offer high throughput, they would also otherwise complicate scheduling because the node B does not know the order in which streams are decoded thereby impacting their effective SINR at the time of decoding.

To combat the above problem, the disclosure also provides additional feedback by the UE, which may include an indicator of whether successive cancellation is used, and if so, the order of the streams decoded. This allows the node B to ensure that while coding across multiple resource blocks, it always codes the first detected stream in each block together, and the second detected streams together, and so on.

In another embodiment, the base station may ensure that whenever multi-user scheduling is done, the stream sent to each UE is always the first stream detected by it according to the detection order fed back by the UE.

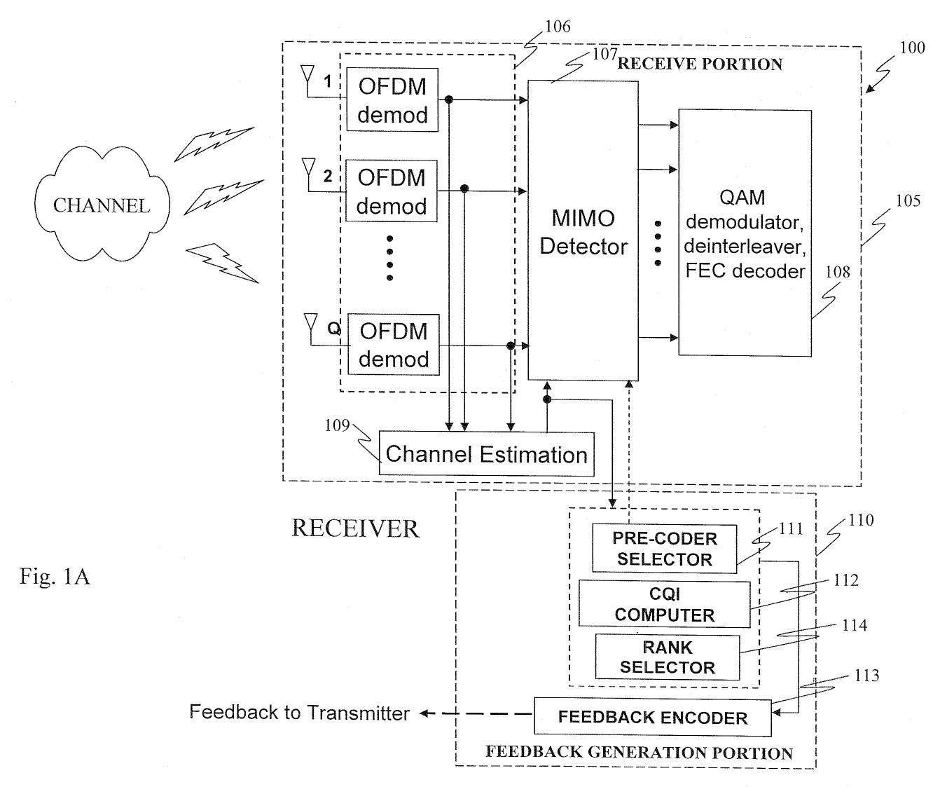

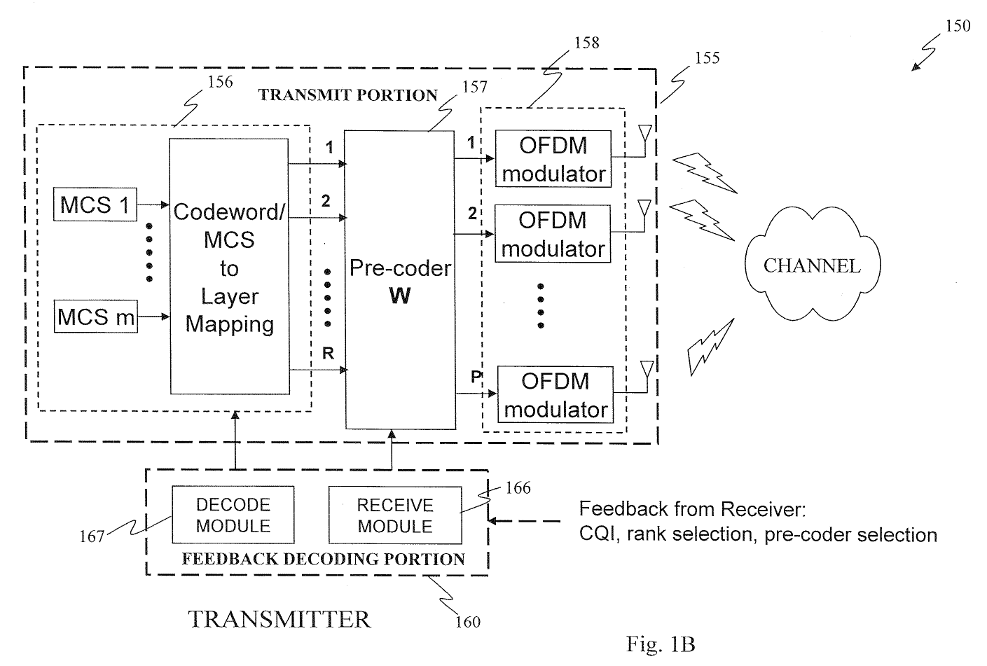

FIG. 1A illustrates a system diagram of a receiver 100 as provided by one embodiment of the present disclosure. In the illustrated embodiment, the receiver 100 operates in an OFDM communications system as a user equipment (UE). The receiver 100 includes a receive portion 105 and a feedback generation portion 110. The receive portion 105 includes an OFDM module 107 having Q OFDM demodulators (Q is at least one) coupled to corresponding receive antenna(s), a MIMO detector 107, a QAM demodulator plus de-interleaver plus FEC decoding module 108 and a channel estimation module 109. The feedback portion 110 includes a pre-coder selector 111, a CQI computer 112, a rank selector 114, and a feedback encoder 113.

In the receiver 100, the receive portion 105 employs transmission signals from a transmitter having multiple transmit antennas that is capable of transmitting at least one spatial codeword and adapting a transmission rank. Additionally, the feedback generator portion 110 is configured to provide a channel quality indicator that is feedback to the transmitter, wherein the channel quality indicator corresponds to at least one transmission rank.

The receive portion 105 is primarily employed to receive data from the transmitter based on a pre-coder selection that was determined by the receiver and feedback to the transmitter. The OFDM module 106 demodulates the received data signals and provides them to the MIMO detector 107, which employs channel estimation and pre-coder information to further provide the received data to the module 108 for further processing (namely QAM demodulation, de-interleaving, and FEC decoding). The channel estimation module 109 employs previously transmitted channel estimation signals to provide the channel estimates need by the receiver 100.

The feedback generation portion 110 determines the information to be fed back to the transmitter. It comprises the rank selector 113, the precoder-selector 111 and the CQI computer 112. For each possible transmission rank (or some subset thereof), the pre-coder selector 111 and the CQI computer 112 determine the precoder and CQI feedback. These modules use the channel and noise-variance/interference estimates computed by the receiver. The rank-selector 114 then makes a choice of the set of ranks for which the information needs to be fed back. The feedback encoder 113 then encodes the pre-coder selection and the CQI information and feeds it back to the.

FIG. 1B illustrates a system diagram of a transmitter 150 as provided by one embodiment of the present disclosure. In the illustrated embodiment, the transmitter operates in an OFDM communication system as a base station (node B). The transmitter 150 includes a transmit portion 155 and a feedback decoding portion 160. The transmit portion 155 includes a modulation and coding scheme module 156, a pre-coder module 157 and an OFDM module 158 having multiple OFDM modulators that feed corresponding transmit antennas. The feedback decoding portion 160 includes a receiver module 166 and a decoder module 167.

The transmitter 150 has multiple transmit antennas and is capable of transmitting at least one spatial codeword and adapting a transmission rank. The feedback decoding portion 160 is configured to extract a channel quality indicator provided by a feedback signal from a receiver (such as the receiver 100), wherein the channel quality indicator corresponds to at least one transmission rank. The transmit portion 155 is coupled to the multiple transmit antennas and provides a subsequent transmission based on the channel quality indicator.

The transmit portion 155 is employed to transmit data provided by the MCS module 156 to the receiver based on pre-coding provided by the pre-coder module 157. The MCS module 156 takes m codewords (m is at least one) and maps the codeword(s) to the R spacial layers or transmit streams, where R is the number of transmission ranks, which is at least one. Each codeword consists of FEC-encoded, interleaved, and modulated information bits. The selected modulation and coding rate for each codeword are derived from the CQI. A higher CQI typically implies that a higher data rate may be used. The pre-coder module 157 may employ a pre-coder selection obtained from the feedback decoding portion 160.

The receive module 166 accepts the feedback of this pre-coder selection, and the decode module 167 provides them to the pre-coder module 157. Once the R spatial stream(s) are generated from the MCS module 156, a pre-coder is applied to generate P≧R output streams. The pre-coder W is selected from a finite pre-determined set of possible linear transformations or matrices, which may correspond to the set that is used by the receiver. Using pre-coding, the R spatial stream(s) are cross-combined linearly into P output data streams. For example, if there are 16 matrices in the pre-coding codebook, a pre-coder index corresponding to one of the 16 matrices for the resource block (say 5, for example) may be signaled from the receiver to the transmitter for each group of resource blocks. The pre-coder index then tells the transmitter 150 which of the 16 matrices to use.

Referring jointly to FIGS. 1A and 1B, CQI feedback schemes to support optimum rank adaptation and UE selection for a multi-codeword (MCW) transmission and a single-codeword (SCW) transmission are presented. In the MCW transmission, each stream is coded separately. The CQI feedback provided by the CQI computer 112 and the rank selector 113 for each stream closely reflects the error probability achievable for that stream for each possible available data rate. The error probability for a given data rate depends on the MIMO equalization method used. The post-equalization SINR for each stream may be computed based on channel and noise-variance estimates.

For any equalizer, the CQIs depend on the pre-coding matrix or the number of selected antennas, and hence on the rank. For each possible rank R, the UE computes the best pre-coder or selected antenna indices. It also obtains R SINRs and quantizes them, either directly or after some transformation. Two exemplary feedback schemes are complete feedback and best-rank feedback.

For complete feedback, the pre-coder/selection index and CQI are fed back for each rank. For example, if the number of transmit antennas equals two, the UE (the receiver 100) would feed back two CQIs for a rank-2 transmission along with an antenna index or pre-coder index, and one CQI for a rank-1 transmission.

For best-rank feedback, the receiver 100 selects a rank R*, typically the rank that maximizes the throughput, and feeds back the corresponding pre-coding/selection index and CQI values corresponding to rank R*. The number of CQIs depends on the number of codewords associated with rank R* Note that best-rank feedback reduces the amount of information to be fed back.

Operation of the transmitter 150 (the node B) using each of the above CQI feedback schemes may be described. The node-B operation depends on whether single-user or multiple-user transmission in each resource block is planned.

In single-user (SU) transmission, the node-B has to decide, for each resource block, the scheduled UE on that resource block, and the number of streams transmitted along with the data rate, or equivalently, the modulation and coding scheme (MCS) for each stream.

A selection scheme for each resource block may be as follows. For each UE, compute the best rank, MCS on each stream and cumulative throughput. Using the throughputs calculated and possibly correcting for long-term average throughput, select the UE to be scheduled on that resource block. Typically, the criterion used is the fairness scaled throughput, namely the average throughput divided by the long-term average throughput. Then, the UE with the maximum fairness scaled throughput for the current resource block is scheduled. Schedule the UE selected with rank and data rates determined above. If necessary, select a common data rate for the same stream to the same UE across different resource blocks.

For single-user transmission, note that only the best rank and the corresponding SINRs, as computed are necessary for scheduling. Thus, best-rank feedback gives the same result as complete feedback, with significantly less overhead. It may be concluded that best-rank feedback is a preferred feedback mode for the single-user transmission.

Before proceeding with feedback and scheduling algorithms for a multiple-user (MU) transmission, it must be noted that MU is not always feasible, with certain types of receivers, as listed below. The fundamental issue is that for some decoders, the CQI on one stream is dependent on the modulation and coding scheme on another stream and therefore different streams cannot be scheduled to different UEs.

Successive interference cancellation (SIC) decoders iteratively decode one stream by nulling interferers, and then canceling the decoded stream for further iterations. Thus, the CQI fed back by each UE for the second stream implicitly assumes that the first stream was accurately been cancelled. This is possible only if the first stream has the MCS required by that UE.

For non-linear ML or near-ML decoders, the CQI on each stream depends on the modulation schemes used on the other streams. Thus, for accurate CQI feedback, the UE must again be able to predict the modulation scheme on each stream, which is not possible for a MU transmission. Thus, ML decoders are also more compatible with SU transmission. At any rate, sophisticated ML decoders are more compatible with SCW transmissions.

Assuming that the above restrictions are not applicable and that the CQI of each stream is independent of the MCS transmitted on the other streams, the node B has to provide the following for each resource block (or group of resource blocks, known as sub-band or chunk): the best rank or number of streams, and for each stream, the UE and the data rate.

The scheme for each resource block (or sub-band) may be as follows. For each rank R, select the optimum UEs and data rates for each of the R streams. This is done independently for all R spatial layers based on the rank R CQIs fed back from each UE. Thus, for stream i, the i-th rank R CQI fed back from each UE is used to calculate the data rate and throughput. The UE with the maximum scaled throughput is scheduled on that stream. From all the ranks thereby evaluated, select the best rank R* (typically the one that maximizes the sum scaled throughput across streams). From the rank chosen, schedule the optimum UEs and data rates selected.

The first part of the scheme ideally requires CQIs fed back for each UE and each rank R. With best-rank feedback, this is not always available. Thus, best-rank feedback does impact performance with MU transmission. In this case, the first part of the scheme considers only those UEs whose best rank is R.

Additionally, for a given rank, different UEs may not have the same pre-coder/antenna selection indices. To handle this, the first part is modified so that for each rank, the node B considers all possible selection indices. For each selection index, only UEs with that particular feedback index (if any) are considered while determining the optimum choice of UE and data rate for each stream.

An alternative scheme for MU transmission may be described as follows. For a given number of maximum streams N, which is less than or equal to the number of transmit antennas, each UE feeds back N CQIs to the node B assuming multi-stream reception (e.g., with an LMMSE receiver). The node B decides the scheduling strategy (i.e., SU or MU) depending on the NK CQIs (where K is the number of active UEs). That is, based on the NK CQIs, the node B separately selects the best user for each of the streams.

This scheme allows an automatic or dynamic switching between SU and MU MIMO scheduling. For example, at low geometry MU-MIMO scheduling is more likely (since rank 1 transmission is more likely for each user). On the other hand, SU-MIMO is more likely at higher geometry since the probability of the same user having the best CQIs for all the streams is higher (i.e., spatial multiplexing is more likely for each user). The drawback of this technique is the CQI overhead required a further CQI reduction scheme may be employed. For example, encoding the absolute CQI for one stream and differential CQIs for the other streams.

In a SCW transmission, the data streams are jointly coded. Thus, the coding scheme is the same for all streams, though the modulation scheme may vary depending on the CQI. Also, note that since coding across streams is assumed, all streams must be transmitted to the same UE. Thus, the SCW transmission is fundamentally incompatible with MU MIMO. Consequently, as discussed above, best-rank feedback is optimum for SCW transmission. The feedback and scheduling schemes are described below.

For feedback mechanisms for each possible rank R, the UE computes the best pre-coding/antenna selection and the corresponding post-equalization SINR. The SINRs are used to determine the optimum joint code rate as well as the optimum modulation schemes on each stream. The throughput for each rank is also calculated. The rank R* with the best throughput is the selected best rank. The corresponding CQIs and pre-coding index are fed back.

The scheduling algorithm is similar to the one discussed above, except for the modification to calculate the effective throughput of the jointly coded system. The procedure followed, for each resource block, is as follows. For each UE, use the CQIs fed back to determine the optimum modulation schemes, the joint code rate and the effective throughput. Then using the throughputs calculated in the first part, select the UE with the best fairness-scaled throughput. Finally, schedule UE selected in the second part with modulation schemes and code rates determined in the first part. If necessary, select a common data rate for the same stream to the same UE across different resource blocks or sub-bands. The various CQI feedback and scheduling algorithms discussed above may be summarized in Table 1 below.

TABLE 1

Feedback Mechanism

| Coding | Multi- | Best-rank | Complete |
|---|---|---|---|
| Scheme | user | Feedback | Feedback |
| Multi- | Single- | Optimum | Not |
| | Multi- | Sub- | Optimum |
| Single- | Single- | Optimum | Not |
| | Multi- | Not | Not feasible |

In the case of single-rank feedback, the CQI may also be fed back in the form of modulation and coding schemes instead of SINR.

Feedback signals from the UE may be designed to support dynamic adaptation of rank adaptation, UE selection, modulation and coding schemes and channel pre-coding schemes. In particular, sufficient information may be fed back to allow the UE to switch between SU and MU scheduling on a given resource block thereby providing a robust feedback scheme.

Enabling dynamic switching between SU and MU MIMO provides several challenges. The best-rank feedback scheme described above works well for single-user scheduling, because it gives the node B all the information needed for choosing the UE to be scheduled on a resource block and for doing pre-coding and link adaptation for that UE. However, best-rank feedback does not enable MU scheduling.

For example, consider the case of N_{T} equal to two transmit antennas. To illustrate this, suppose two different UEs choose rank one transmission with some respective pre-coding matrices. The node B may desire to exploit the orthogonality of the UEs pre-coding vectors to simultaneously schedule the two UEs on the same resource block. However, doing so increases the transmission rank to two and the UE does not know the CQI of each UE having a rank 2 transmission. The critical problem is that best-rank feedback allows the UE to determine the transmission rank, thus precluding simultaneous scheduling of two different low-rank UEs simultaneously.

Complete feedback offers a solution to this problem, where the UE sends CQI and pre-coding information for all possible ranks. Such a scheme allows multi-user scheduling but is clearly wasteful of uplink bandwidth, since unused feedback information is transmitted all the time. To strike a balance between scheduling dynamism and uplink feedback requirement, a multi-rank feedback scheme may be employed.

Here, the UE feeds back the choice of pre-coding matrix or grouping corresponding to Ns streams as well as the stream CQI for the best rank and some other rank. Typically, only one other rank is fed back, and it is one rank higher or lower than best rank. The other rank is also signaled. A few other embodiments are possible. Each UE does best-rank feedback most of the time and multi-rank feedback every few TTIs. Additionally, the node B sends a request to the UE to determine whether best- or multi-rank feedback is used. Also, the node-B might also specify which additional rank is fed-back.

Above, multi-rank feedback was presented to handle dynamic SU/MU switching for the case where the UE employs stream-independent decoders. However, as discussed briefly, some UEs might employ successive interference cancellation (SIC) decoding. In SIC decoding, the first stream is decoded after nulling the interference from other streams. It is then re-encoded and its interference to the remaining streams is cancelled. The second stream is then decoded, and so on. Note that the each stream can be decoded using an LMMSE or ML decoder or any other technique used in stream-independent decoders. The advantage of doing so is that later streams have lesser interference and can therefore support higher data rate.

The use of SIC, however, complicates multi-user MIMO. The reason is that each UE has to decode the first stream in order to decode the subsequent ones. It is assumed that UEs cannot decode streams intended for other UEs. One reason this occurs is that the UE may not have access to the needed control information. Another reason is that the other stream may be scheduled at a higher data rate than the UE can accurately decode.

This would usually pose a problem for CQI feedback since if the UE reports CQIs for an SIC decoder, the node B cannot use those CQIs while operating in MU mode. Even with the configuration above, there is a problem for dynamic switching between SU and MU MIMO. In particular, if a given UE is operating in SU MIMO mode and feeding back information assuming an SIC decoder, the node B cannot determine whether multi-user scheduling would be beneficial.

To combat these issues, the following feedback schemes are presented. For multi-rank feedback, the other rank always assumes independent stream decoding. This assumes that the other rank is intended for MU MIMO and the best rank for SU MIMO. In this case, “best” simply refers to maximum SINR, since it does not necessarily imply maximum sum throughput. If the UE computes its best-rank CQIs assuming SIC, this is indicated to the node B. This indication does not have to be done every time. Also, the node B can configure the UE to enable or disable SIC.

If the UE computes the best-rank CQIs assuming SIC, it also feeds back the index of the first stream. To illustrate the utility of this signal, consider the case where UE1 decodes stream 1 first and UE2 decoders stream 2 first. Since the node B knows this, it can potentially schedule UE1 on stream 1 and UE2 on stream 2, even though the other CQI, obtained assuming SIC, is not meaningful for either UE. Again, this indicator can be sent at a lower rate than the CQI. Also, the node B can signal the UE to enable or disable this signal.

The node-B uses the proposed feedback signals to achieve dynamic SU/MU scheduling by deciding if there is sufficient traffic to warrant multi-user scheduling. If there is not sufficient traffic, it enables SIC in all SIC-capable UEs and reduces the frequency of multi-rank feedback. If there is enough traffic, it increases the frequency of multi-rank feedback. For each resource block, the node B does the following search.

For every possible rank, it employs the following options. Schedule one UE, whose best rank is the current rank, in single-user mode. Next, schedule multiple UEs whose best rank is the current rank and which have the same pre coding matrix, but different “first streams”. Then, schedule some UEs with their best rank and some others with their “other rank” wherein these UEs should have the same pre-coding matrix.

For each rank, the node B chooses the option that maximizes the fairness-scaled throughput. Then it picks the scheduling corresponding to the rank which has the best fairness-scaled throughput. If multi-user scheduling is done on any RB, the UEs feed back information specific to MU scheduling and reduce the rate of SU feedback (i.e., SIC-related feedback).

When common modulation and coding schemes are used for all the K streams, only one CQI is needed to convey the channel condition experienced by the SCW transmission. However, when the modulation schemes for different streams are adapted based on the channel fading, a single CQI cannot accommodate the need for the transmitter to assign different modulation schemes for different streams despite the commonality of the coding scheme. Hence, like MCW transmissions, multiple CQIs are needed for SCW transmissions.

When adapting the modulation schemes across streams at the channel fading rate is supported, the UE feeds back K channel quality indicator words for the transmission of K streams. CQIs for multiple transmission ranks K can be fed back, if necessary. The CQIs reflect the post-equalization channel-to-interference ratio (CINR) on each stream. The CINR feedback is suitable when the MCS selection is performed at the node B. This represents a wide variety of systems such as LTE UMTS.

An alternative is to feed back the preferred modulation scheme index for each stream along with the joint coding scheme. Additionally, some information about the relative accuracy with which the UE can support the recommended modulation and coding scheme may also be provided.

The CQIs for different streams are jointly quantized to reduce the feedback rate. One illustrative embodiment is the use of incremental CINR feedback, where the first CINR is quantized to 5 bits, and the difference between the first and second CINR is quantized to 3 bits, and so on. In a further refinement, the CINRs may be ordered before incremental quantization, and the ordering index fed back separately.

For SCW, the modulation adaptation may be performed at a slower rate (e.g., based on the long-term/slow fading). For this case, the following CQI feedback scheme may e used. The first CQI that represents the overall SINR (across streams) as a result of using one codeword is used and fed back at a regular CQI feedback rate. Then, the second, third, through Kth CQIs, which represent the differential CQIs that are used for adapting the modulation schemes for stream 2, 3, through K are transmitted at a significantly slower rate. These differential CQIs are typically averaged over the feedback interval of these differential CQIs.

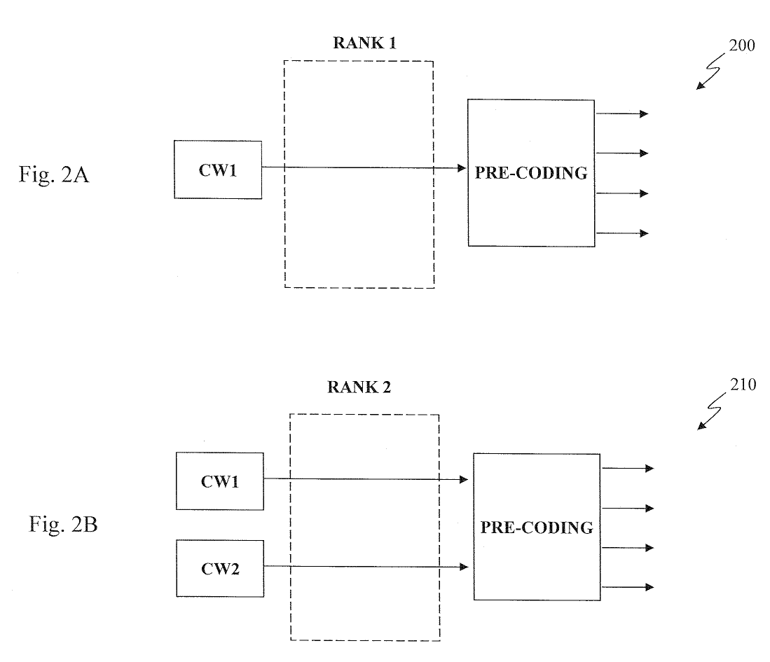

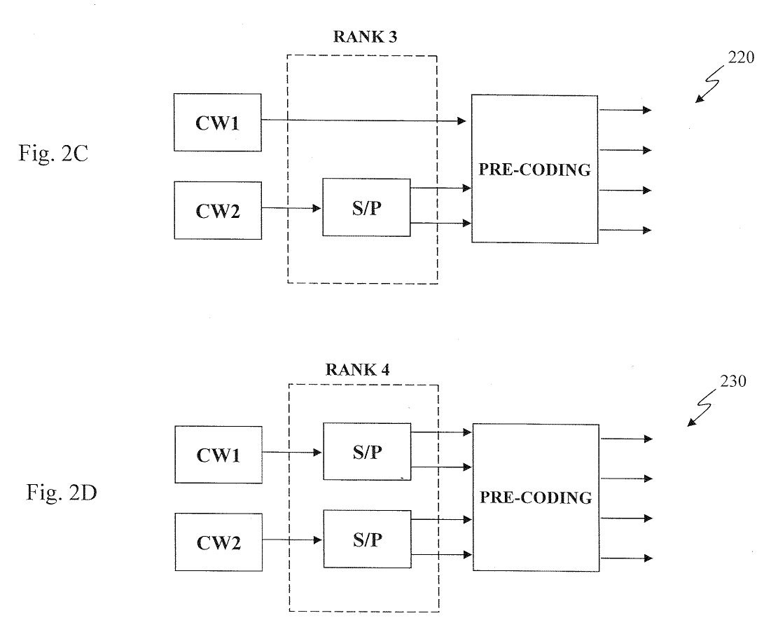

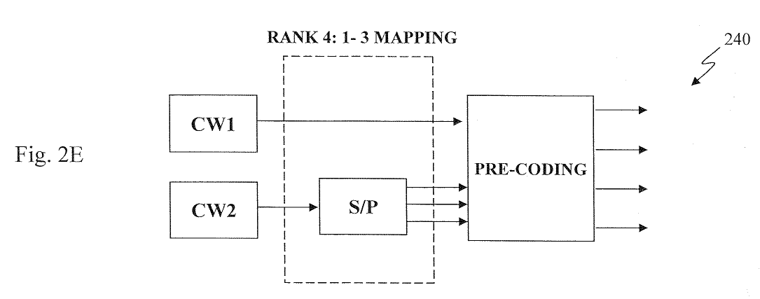

FIGS. 2A-2E illustrate diagrams of various transmitter configurations 200-240 as provided by various embodiments of the disclosure. Per group rate control (PGRC), as depicted in FIGS. 2A-2E, is an efficient 4-antenna transmission scheme that achieves the performance of 4-codeword transmission (per antenna rate control—PARC) while reducing the total uplink and downlink overhead.

Five different codeword-to-layer (CW2L) mapping are shown. The grouping or any other possible linear transformation is basically a form of codebook-based pre-coding. The CW2L mapping is fixed. Pre-coding adapts to the channel fading. While the configurations of FIGS. 2A-2D achieve the best performance, a possible variant to the rank-4 configuration is the 1-3 mapping pattern shown in FIG. 2E. There are two possible CQI definitions for PGRC: CQI per codeword and CQI across layers.

Based on the structures depicted, it seems natural to define the CQI per codeword. That is, for rank 1, only 1 CQI is needed. For rank ≧2, two CQIs are needed, wherein each is associated with one codeword. The two CQIs can be:

Two full CQIs corresponding to the two codewords:

CQI₁ and CQI₂.

Or, one full (base) CQI and one delta CQI:

CQI_{base} and CQI_{delta}.

CQI_{base} may be defined either as the CQI of the first codeword or the maximum CQI of the 2 codewords. Then, CQ_{delta} is simply the difference between CQ_{base} and the CQI of the other codeword. Note that the second alternative requires an additional feedback indicating the codeword corresponding to the maximum CQI. While delta CQI is most suitable for SINR-based CQI definition, it is also applicable for some other CQI definitions.

CQI_{base}=CQI₁ CQI_{base}=max(CQI₁,CQI₂)

or

CQI_{delta}=CQI₂−CQI₁ CQI_{delta}=CQIₒₜₕₑᵣ−CQI_{base} (1)

The CQIs are computed from the channel, noise variance, or interference estimates. Once computed, the CQIs are quantized. Due to the inherent correlation between CQI₁ and CQI₂, CQI_{delta} requires fewer bites than CQI_{base} since the dynamic range for CQI_{delta} is smaller. In frequency selective channels with OFDMA, the CQI may be computed per group of tones. For overhead saving, some type of CQI feedback reduction scheme across different frequencies may be used, such as the polynomial-based compression or best-M method.

Alternatively, it is also possible to define the CQI across layers. This definition is identical to the previous embodiment for transmission rank 1 and 2. For rank 23, a somewhat inefficient way to do this is to feedback the CQIs for all the layers. In this case, rank 3 transmission requires three CQIs (C₁,C₂,C₃) and rank 4 transmission requires four CQIs (C₁,C₂,C₃,C₄). A more efficient way is to feedback only two quantities/parameters and reconstruct per layer CQIs from those two quantities with some approximation error. In this manner, the feedback overhead for rank 3 and rank 4 is identical to that for rank 2. While there may be several ways to do this, one scheme is illustrated below wherein a rank 4 transmission is assumed.

Two CQIs are fed back wherein there is one base CQI corresponding to the maximum CQI across layers (or the mean/median CQI across layers), and one delta CQI which is computed as a function of the differences between the base CQI and the other CQIs. For example, the delta CQI can be defined as the arithmetic average of all the differences so that each CQI layer can be reconstructed using an affine linear approximation. That is:

$${C}_{( 1 )} \geq {C}_{( 2 )} \geq {C}_{( 3 )} \geq {C}_{( 4 )} \\ {CQI}_{base} = {C}_{( 1 )} \\ {Δ}_{n} = {CQI}_{base} - {C}_{( n )} \\ {CQI}_{delta} = ( {Δ}_{2} + \frac{{Δ}_{3}}{2} + \frac{{Δ}_{4}}{3} ) / 3 \qquad ( 2 )$$

At the node B, the CQI for each layer may be reconstructed from the base and delta CQIs (e.g., based on an affine linear approximation with some approximation error). Consequently, the CQI for each codeword may be derived from the reconstructed layer CQIs. For example, based on the model in equation set (2), the CQI per layer can be reconstructed (with an approximation error) as follows:

Ĉ₍₁₎=CQI_{base}

Ĉ₍ₙ₎=Ĉ₍₁₎+(n−1)CQI_{delta} (3)

This scheme requires some additional feedback to indicate the ordering of the per layer CQI (24 possibilities) It is also possible to feed back only a partial layer ordering (e.g., only the index of the layer with the largest CQI or the indices of the layers with the two largest CQIs). For rank 3 transmissions, equation set (2) may be modified as follows:

$${C}_{( 1 )} \geq {C}_{( 2 )} \geq {C}_{( 3 )} \\ {CQI}_{base} = {C}_{( 1 )} \\ {Δ}_{n} = {CQI}_{base} - {C}_{( n )} \\ {CQI}_{delta} = ( {Δ}_{2} + \frac{{Δ}_{3}}{2} ) / 2 \qquad ( 4 )$$

While the second embodiment suffers from some approximation error due to the affine linear model and requires some additional feedback, it allows a full flexibility at the Node B. For example, the Node B can switch between two different CW2L mappings. Also, this embodiment allows fast/dynamic switching between single-user and multi-user MIMO.

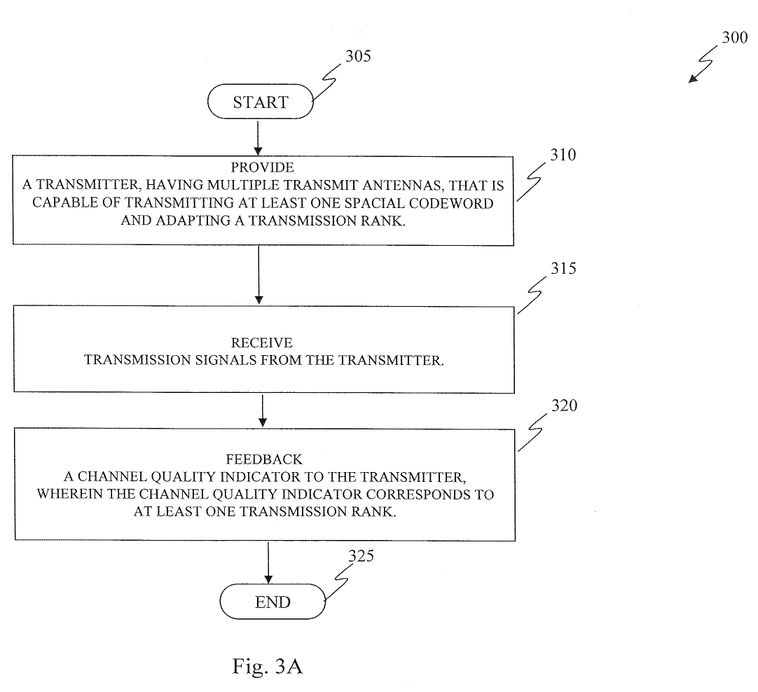

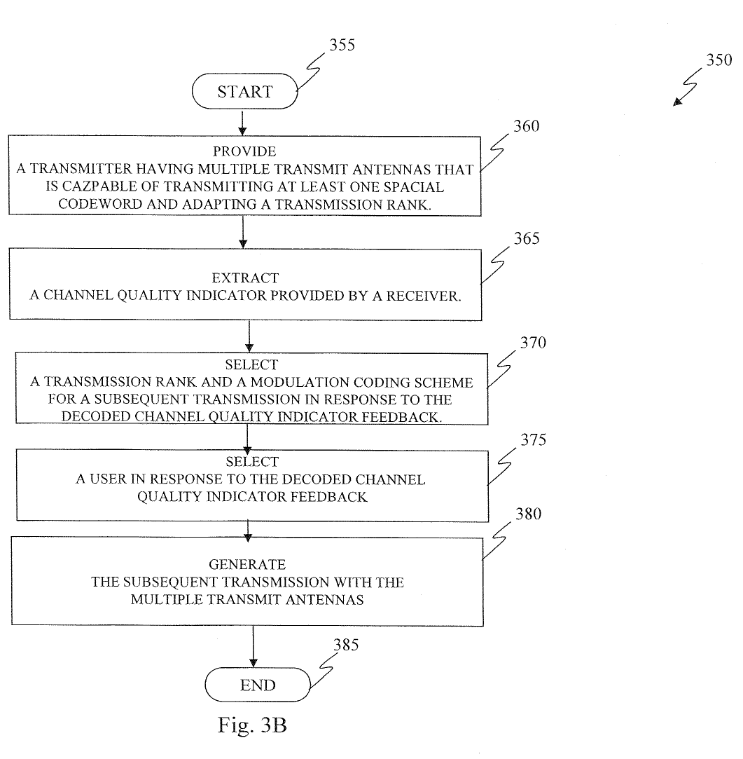

FIG. 3A illustrates a flow diagram of an embodiment of a method 300 of operating a receiver. The method 300 starts in a step 305. Then, in a step 310, a transmitter is provided that is capable of transmitting at least one spacial codeword and adapting a transmission rank. In a step 315, transmission signals from the transmitter are received. Further, a channel quality indicator is feed back to the transmitter that corresponds to at least one transmission rank in a step 320.

In one embodiment, the channel quality indicator corresponds to a preferred transmission rank. Alternatively, the channel quality indicator corresponds to a channel quality of a plurality of transmission ranks. Additionally, the channel quality indicator may correspond to at least one transmission rate recommendation.

In another embodiment, the channel quality indicator corresponds to a channel quality across at least one spatial codeword. Alternatively, the channel quality indicator corresponds to a second spatial codeword that is represented as a difference relative to another channel quality indicator corresponding to another spatial codeword. Additionally, the channel quality indicator corresponds to the channel quality across distinct spatial codewords for a multiple codeword transmission. Further, the channel quality indicator corresponds to a channel quality across distinct spatial layers.

In yet another alternative embodiment, the channel quality indicator corresponds to a channel quality of a single spatial codeword transmission. Alternatively, the channel quality indicator is accompanied by a successive interference cancellation indicator for performing successive interference cancellation.

In still another embodiment, the channel quality indicator corresponds to at least one signal-to-interference-plus-noise ratio (SINR) parameter. Alternatively, the channel quality indicator is accompanied by a detection ordering indicator. The method 300 ends in a step 325.

FIG. 3B illustrates a flow diagram of an embodiment of a method 350 of operating a transmitter. The method 350 starts in a step 355. Then, in a step 360, a transmitter is provided having multiple transmit antennas that is capable of transmitting at least one spatial codeword and adapting a transmission rank. A channel quality indicator provided by a feedback signal from a receiver is extracted in a step 365, and transmission rank and a modulation-coding scheme for the subsequent transmission are selected in response to the decoded channel quality indicator feedback in a step 370. Then, in a step 375, a user is selected in response to the decoded channel quality indicator feedback of step 370. A subsequent transmission with the multiple transmit antennas is generated in a step 380.

In one embodiment, the transmission employs a plurality of spatial codewords for transmission rank higher than one and an independent modulation-coding scheme selection across the distinct spatial codewords. Additionally, the transmission employs a single spatial codeword for transmission rank higher than one and an independent modulation scheme selection across the distinct spatial layers.

In another embodiment, each user is assigned to a layer corresponding to the first layer indicated in a detection ordering indicator for transmitting to multiple users across distinct spatial layers. Alternatively, the transmitter adapts a codeword-to-layer mapping in response to a channel quality indicator feedback that is defined across spatial layers the transmitter adapts a codeword-to-layer mapping in response to a channel quality indicator feedback that is defined across spatial layers.

In yet another embodiment, the transmission employs a single spatial codeword for transmission rank higher than one and selects a single modulation-coding scheme for the distinct spatial layers. Also, an ordering is performed across spatial layers in response to a detection ordering and a successive interference cancellation indicator feedback from the receiver.

In still another embodiment, a channel quality indicator is reconstructed from a channel quality indicator feedback consisting of a base and at least one delta channel quality indicator. The method 350 ends in a step 385.

Those skilled in the art to which the disclosure relates will appreciate that other and further additions, deletions, substitutions and modifications may be made to the described example embodiments without departing from the disclosure.

What is claimed is:

1. A receiver, comprising:
a receive portion employing transmission signals from a transmitter having multiple transmit antennas that is capable of transmitting at least one spatial codeword and adapting a transmission rank; and
a feedback generator portion configured to provide a channel quality indicator that is feedback to the transmitter, wherein the channel quality indicator corresponds to at least one transmission rank.

2. The receiver as recited in claim 1 wherein the channel quality indicator corresponds to a preferred transmission rank.

3. The receiver as recited in claim 1 wherein the channel quality indicator corresponds to a channel quality of a plurality of transmission ranks.

4. The receiver as recited in claim 1 wherein the channel quality indicator corresponds to a channel quality across at least one spatial codeword.

5. The receiver as recited in claim 4 wherein the channel quality indicator corresponding to a spatial codeword is represented as a difference relative to another channel quality indicator corresponding to another spatial codeword.

6. The receiver as recited in claim 4 wherein the channel quality indicator corresponds to a channel quality across distinct spatial codewords for a multiple codeword transmission.

7. The receiver as recited in claim 1 wherein the channel quality indicator corresponds to a channel quality across distinct spatial layers.

8. The receiver as recited in claim 1 wherein the channel quality indicator corresponds to at least one signal-to-interference-plus-noise ratio (SINR) parameter.

9. The receiver as recited in claim 1 wherein the channel quality indicator corresponds to at least one transmission rate recommendation.

10. The receiver as recited in claim 1 wherein the channel quality indicator corresponds to a channel quality of a single spatial codeword transmission.

11. The receiver as recited in claim 1 wherein the channel quality indicator is accompanied by a successive interference cancellation indicator for performing successive interference cancellation.

12. The receiver as recited in claim 11 wherein the channel quality indicator is accompanied by a detection ordering indicator.

13. A method of operating a receiver, comprising:
receiving transmission signals from a transmitter having multiple transmit antennas that is capable of transmitting at least one spatial codeword and adapting a transmission rank; and
feeding back a channel quality indicator to the transmitter, wherein the channel quality indicator corresponds to at least one transmission rank.

14. The method as recited in claim 13 wherein the channel quality indicator corresponds to a preferred transmission rank.

15. The method as recited in claim 13 wherein the channel quality indicator corresponds to a channel quality of a plurality of transmission ranks.

16. The method as recited in claim 13 wherein the channel quality indicator corresponds to a channel quality across at least one spatial codeword.

17. The method as recited in claim 16 wherein the channel quality indicator corresponding to a second spatial codeword is represented as a difference relative to another channel quality indicator corresponding to another spatial codeword.

18. The method as recited in claim 16 wherein the channel quality indicator corresponds to the channel quality across distinct spatial codewords for a multiple codeword transmission.

19. The method as recited in claim 13 wherein the channel quality indicator corresponds to a channel quality across distinct spatial layers.

20. The method as recited in claim 13 wherein the channel quality indicator corresponds to at least one signal-to-interference-plus-noise ratio (SINR) parameter.

21. The method as recited in claim 13 wherein the channel quality indicator corresponds to at least one transmission rate recommendation.

22. The method as recited in claim 13 wherein the channel quality indicator corresponds to a channel quality of a single spatial codeword transmission.

23. The method as recited in claim 13 wherein the channel quality indicator is accompanied by a successive interference cancellation indicator for performing successive interference cancellation.

24. The method as recited in claim 23 wherein the channel quality indicator is accompanied by a detection ordering indicator.

25. A transmitter having multiple transmit antennas that is capable of transmitting at least one spatial codeword and adapting a transmission rank, comprising:
a feedback decoding portion configured to extract a channel quality indicator provided by a feedback signal from a receiver; wherein the channel quality indicator corresponds to at least one transmission rank; and
a transmit portion coupled to the multiple transmit antennas that provides a subsequent transmission based on the channel quality indicator.

26. The transmitter as recited in claim 25 wherein the feedback decoding portion is further configured to extract a channel quality indicator employed for providing a modulation coding scheme to code the subsequent transmission.

27. The transmitter as recited in claim 25 wherein the feedback decoding portion is further configured to extract a channel quality indicator employed for scheduling the subsequent transmission.

28. The transmitter as recited in claim 25 wherein the transmission employs a plurality of spatial codewords for transmission rank higher than one and an independent modulation-coding scheme selection is performed across the distinct spatial codewords.

29. The transmitter as recited in claim 25 wherein the transmission employs a single spatial codeword for transmission rank higher than one and independent modulation scheme selection is performed across the distinct spatial layers.

30. The transmitter as recited in claim 25 wherein the transmission employs a single spatial codeword for transmission rank higher than one and a single modulation-coding scheme is selected for the distinct spatial layers.

31. The transmitter as recited in claim 25 wherein an ordering is performed across spatial layers in response to a detection ordering and a successive interference cancellation indicator feedback from the receiver.

32. The transmitter as recited in claim 25, wherein each user is assigned to the layer corresponding to the first layer indicated in a detection ordering indicator for transmitting to multiple users across distinct spatial layers.

33. The transmitter as recited in claim 25 wherein a channel quality indicator is reconstructed from a channel quality indicator feedback consisting of a base and at least one delta channel quality indicator.

34. The transmitter as recited in claim 25 wherein the transmitter adapts a codeword-to-layer mapping in response to a channel quality indicator feedback that is defined across spatial layer.

35. A method of operating a transmitter having multiple transmit antennas that is capable of transmitting at least one spatial codeword and adapting a transmission rank, comprising:
extracting a channel quality indicator provided by a feedback signal from a receiver;
selecting a transmission rank and a modulation-coding scheme for a subsequent transmission in response to the decoded channel quality indicator feedback;
selecting a user in response to the decoded channel quality indicator feedback; and
generating the subsequent transmission with the multiple transmit antennas.

36. The method as recited in claim 35 wherein the transmission employs a plurality of spatial codewords for transmission rank higher than one and independent modulation-coding scheme selection across the distinct spatial codewords.

37. The method as recited in claim 35 wherein the transmission employs a single spatial codeword for transmission rank higher than one and an independent modulation scheme selection across the distinct spatial layers.

38. The method as recited in claim 35 wherein the transmission employs a single spatial codeword for transmission rank higher than one and selects a single modulation-coding scheme for the distinct spatial layers.

39. The method as recited in claim 35 wherein an ordering is performed across spatial layers in response to a detection ordering and a successive interference cancellation indicator feedback from the receiver.

40. The method as recited in claim 35 wherein each user is assigned to a layer corresponding to the first layer indicated in a detection ordering indicator for transmitting to multiple users across distinct spatial layers.

41. The method as recited in claim 35 wherein a channel quality indicator is reconstructed from a channel quality indicator feedback consisting of a base and at least one delta channel quality indicator.

42. The method as recited in claim 35 wherein the transmitter adapts a codeword-to-layer mapping in response to a channel quality indicator feedback that is defined across spatial layers.
